(19) United States
(12) Patent Application Publication
(10) Pub. No.: US 2002/0026395 A1
(43) Pub. Date: Feb. 28, 2002

(54) WARRANTY TRACKING SOFTWARE IMPROVEMENT

(76) Inventor: ROGER P. PETERSON, MINNEAPOLIS, MN (US)

Correspondence Address: JONATHAN D SPANGLER, ARNOLD WHITE AND DURKEE, P O BOX 4433, HOUSTON, TX, 772104433

(21) Appl. No.: 09/148,432

(22) Filed: Sep. 4, 1998

Related U.S. Application Data
(60) Provisional application No. 60/057,897, filed on Sep. 8, 1997.

(51) Int. Cl. G06F 17/60

(52) U.S. Cl. 705/35

(57) ABSTRACT

A warranty tracking software improvement to already-existing personal financial software programs which allows rapid and easy posting and retrieval of any warranty or any guarantee associated with any product or service purchased by a consumer.

### BACKGROUND OF THE INVENTION

I. Field of the Invention

The present invention relates generally to the field of organizing personal financial information. More specifically, the present invention relates to a software improvement to an already-existing personal financial software program which provides the ability to easily and rapidly track all warranty and/or guarantee information associated with any purchased product or service, the expense of which is being posted within the already-existing personal financial software.

II. Discussion of the Prior Art

Modern personal computers, such as PCs and Macintosh computers, allow a user to perform many tasks, one of which is personal financial accounting. For example, already-existing personal financial software allows users to easily organize personal finances by balancing checkbooks, reconciling bank statements, tracking cash and credit card transactions, monitoring budgets, tracking investments, writing checks, paying bills electronically, creating various analysis reports, etc. all on a computer.

Such already-existing personal financial software is widely recognized as having met with commercial success, in part, because it has been designed to be “user friendly” with respect to the absence of weighty accounting terms and concepts. Data entry normally consists of merely posting each income or expense item onto a “friendly-looking” computer screen designed to look like the common person's simple checkbook register (see FIG. 2): a date, a check number, a pay-to, an amount, a memo, etc. The computer and the software do all the rest.

The vast majority of all transactions posted within a given user's already-existing personal financial software are payment and/or expense transactions. Many of these same payment and expense transactions are for specific products or services purchased. Many of these same products and services come with a guarantee or warranty for a predetermined period of time, such as 30 days, or 90 days, or one year, or three years, etc. However, the already-existing personal financial software of the prior art does not provide the ability to track these warranty and/or guarantee expiration dates.

Presently the only way a consumer/user can track the warranties and guarantees associated with the products and services he/she purchases, is by creating a “tickler” date-tracking system as a second, separate set of records. A second set of records can be time-consuming, a needless duplication of efforts, and very prone to creating more problems and mistakes. As a result, many consumer/users may not even bother setting up a “tickler” system as a second, separate set of records. Subsequently, consumers/users may inadvertently let their valuable warranties and guarantees expire, simply because they have no easy, manageable way to track and re-call the warranty/guarantee expiration dates. Without an easy, “user friendly” system to track warranty/guarantee expiration dates, consumer/users greatly diminish their opportunity to exercise their personal rights to have a given product or service repaired/replaced prior to the expiration date, under the terms of the given warranty/guarantee, should their given product or service fail to perform under the terms and conditions of the warranty/guarantee.

As is evident from the above information, what is needed is an upgrade modification to the already-existing personal financial software in order to provide the customer/user with an almost effortless way to track guarantees and warranties associated with every product and service purchased without setting up or maintaining a second set of records or another time-consuming “tickler” system. The present invention is directed at overcoming, or at least reducing the effects of, one or more of the problems set forth above.

### SUMMARY OF THE INVENTION

In one aspect of the present invention, a method is provided for tracking warranty information, comprising the steps of: (a) providing a data entry mechanism for entering warranty information into a personal financial software program operating on a computing system; (b) entering warranty information into the personal financial software program; and (c) programming the personal financial software program to notify a user when a warranty within the warranty information is about to expire.

In another broad aspect of the present invention, a method is provided for improving a personal financial software program, comprising the steps of: (a) programming a personal financial software program to include a data entry mechanism for entering warranty information into the personal financial software program; (b) entering warranty information into the personal financial software program; and (c) programming the personal financial software program to notify a user when a warranty expiration date is about to expire.

In a still further broad aspect of the present invention, a method is provided for improving the organization of personal financial information with a personal financial software program operating on a computing system, comprising the steps of: (a) programming a personal financial software program to include a data entry mechanism for entering warranty information; (b) entering warranty information into the personal financial software program; and (c) programming the personal financial software program to notify a user when a warranty expiration date is about to expire.

### BRIEF DESCRIPTION OF THE DRAWINGS

Objects and advantages of the invention will become apparent upon reading the following detailed description and upon reference to the drawings, wherein like numerals denote like elements, in which:

FIG. 1 is a process flow chart depicting the steps employed in utilizing the warranty tracking software improvement of the present invention;

FIG. 2 is an illustration of a checking register screen of an already-existing personal financial software program designed to look like a common checkbook;

FIG. 3 is an illustration of a checking register screen as modified in accordance with the warranty tracking software improvement of the present invention;

FIG. 4 is a partial illustration of the checking register screen shown in FIG. 3 to further detail the warranty tracking features of the present invention;

FIG. 5 is an illustration of a computer screen displaying three exemplary options for automatically signaling a forth-coming warranty/guarantee expiration date in accordance with one embodiment of the present invention;

FIG. 6 is an illustration of a “Transactional Analysis Report” generated by a personal financial software program incorporating the warranty tracking improvement of the present invention;

FIG. 7 is an illustration of a “Create WarrantyMinder Report” dialog box provided in accordance with the present invention for creating a newly-added “WarrantyMinder Report” such as shown in FIG. 8; and

FIG. 8 is an illustration of a “WarrantyMinder Report” generated by a personal financial software program incorporating the warranty tracking improvement of the present invention.

### DETAILED DESCRIPTION OF THE INVENTION

Illustrative embodiments of the present invention are described below. In the interest of clarity, not all features of an actual implementation are described in this specification. It will of course be appreciated that in the development of any such actual embodiment, numerous implementation-specific decisions must be made to achieve the developers' specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure. While the following description presents the best contemplated mode for comprehending, and subsequently utilizing, the invention, this description is not to be taken in a limiting sense, but is made merely for the purpose of describing the general principles of the invention.

By way of overview, the present invention involves an improved computer software program which accomplishes two primary goals. The first goal is to provide the consumer/user of an already-existing personal financial software program to track guarantees and/or warranties associated with every product and service he/she purchases without setting up or maintaining a second set of books or other time-consuming “tickler” systems. The second goal of the present invention is to provide the potential for substantial money-savings to the consumer/user, who often inadvertently overlooks a warranty/guarantee expiration date because of the ever-increasing difficulty to manager such information. Because of the warranty tracking system of the present invention, customers/users will be easily reminded to check and determine whether a given product or service needs to be repaired/replaced under the terms of the respective warranty/guarantee prior to a given warranty/guarantee expiration date, thereby potentially saving the substantial expense of out-of-pocket, costly repair or replacement, should their given product or service fail to perform under the terms and conditions of the warranty/guarantee.

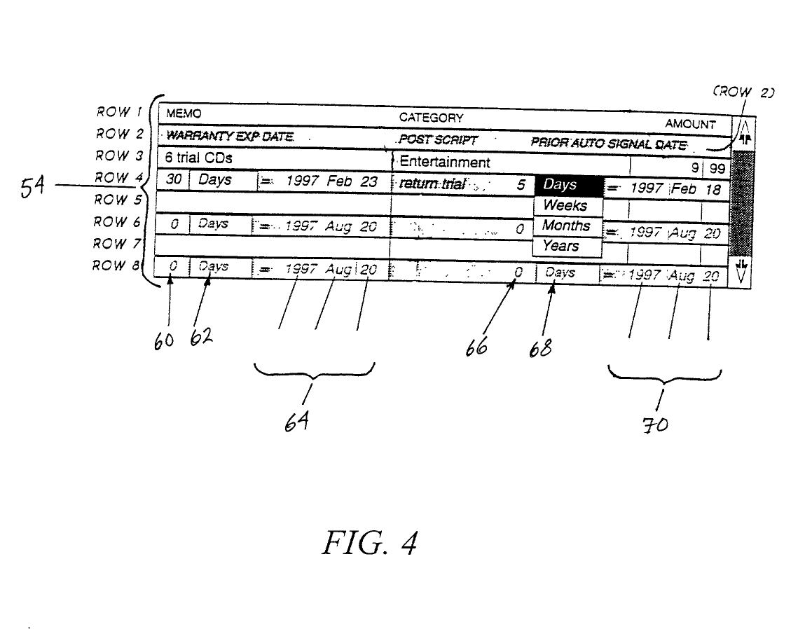

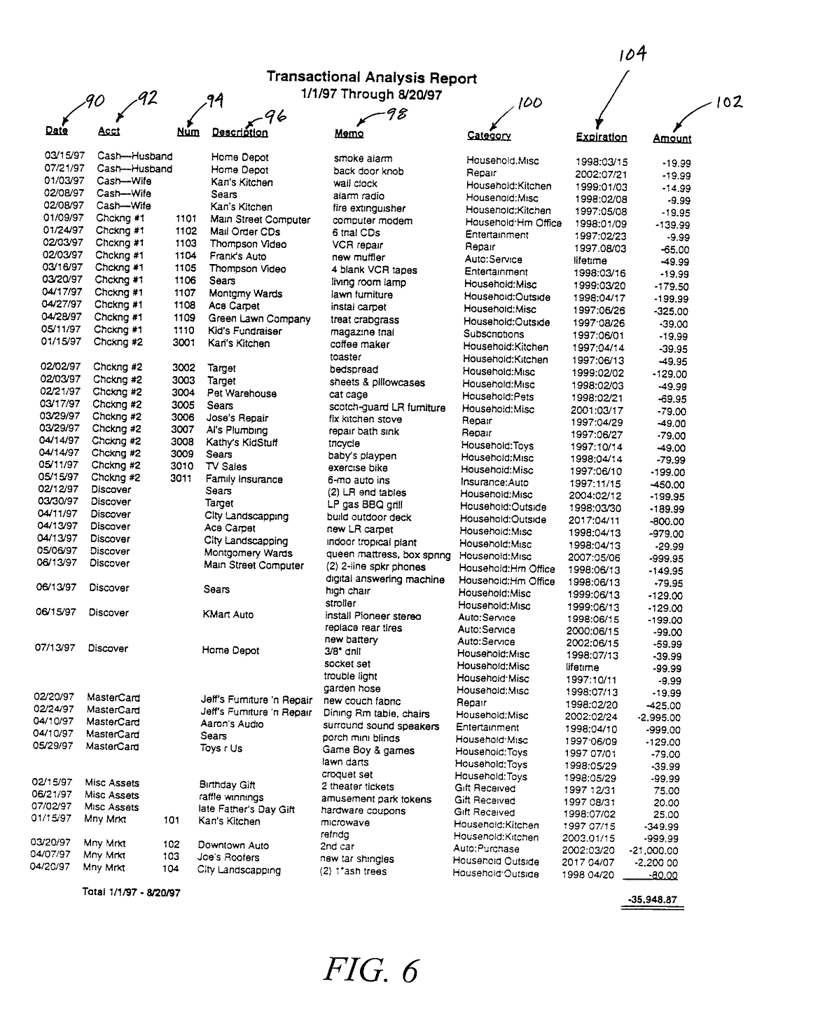

The present invention accomplishes these principle objectives by modifying already-existing personal financial software to provide the consumer/user with the option to easily input one or more additional piece(s) of data in order to fully maintain and track the warranty and/or guarantee expiration dates of every product and service purchased. When the consumer/user records the routine basic data (date, check number, pay-to, memo, amount, etc.) of the expense transaction in his/her personal financial software of a given product or service he/she has purchased, the consumer/user will now have the option to quickly and easily enter basic warranty/guarantee information, specifically the warranty/guarantee expiration date, as a part of this same expense-posting transaction. Subsequent to saving and storing this transaction in the already-existing personal financial software's memory, the personal financial software will now automatically signal the consumer/user (via computer “beep” and/or a flashing I.D. icon and/or a popup dialogue box—see FIG. 4) at a pre-determined future date prior to the warranty/expiration date, as a reminder to the consumer/user to determine whether his/her product or service is still performing under the terms of the warranty/guarantee. The present invention will also cause the personal financial software to automatically provide all warranty/guarantee expiration dates previously entered, via its other various reports (see FIG. 6), as yet another effortless method of managing and reminding the consumer/user to determine whether his/her product or service is still performing under the terms of the warranty/guarantee prior to the expiration date.

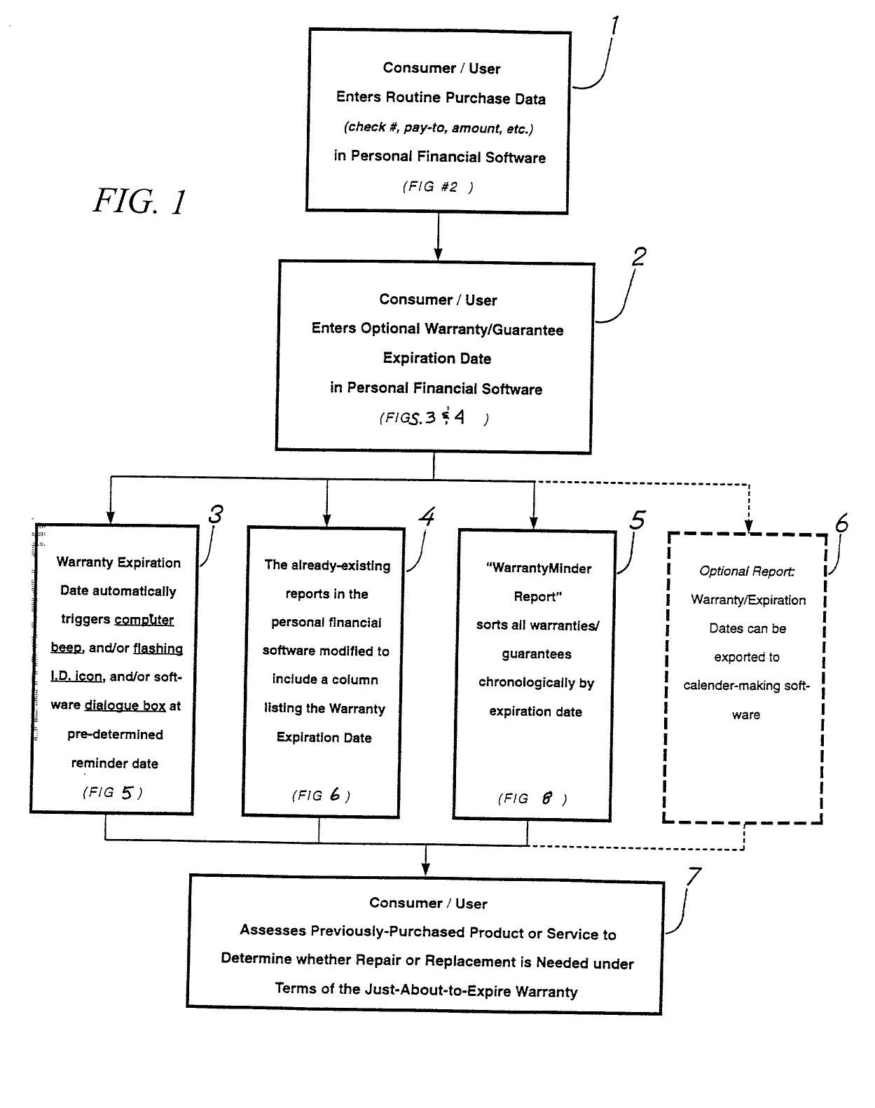

FIG. 1 is a process flow chart depicting the steps employed in utilizing an already-existing personal financial software program that has been upgraded to incorporate the warranty tracking improvements of the present invention. Block 1 denotes the step of allowing a consumer/user to enter routine purchase data via the personal financial software, such as check number, payable to, amount, etc. . . . Block 2 denotes the step of allowing a consumer/user to enter optional warranty and/or guarantee information via the warranty tracking software improvement of the present invention. Blocks 3-6 denote four different methods for notifying the consumer/user of just-about-to-expire warranties. Block 3 includes up to three options for automatically notifying the consumer/user of impending warranty expiration dates. Blocks 4-6 denote three primary types of reports the consumer/user may choose to create as a means of notification. Block 7 denotes the step of allowing the consumer/user to assess previously-purchased products and services to determine whether repair or replacement is needed under the terms and conditions of a given warranty/guarantee prior to the warranty expiration date.

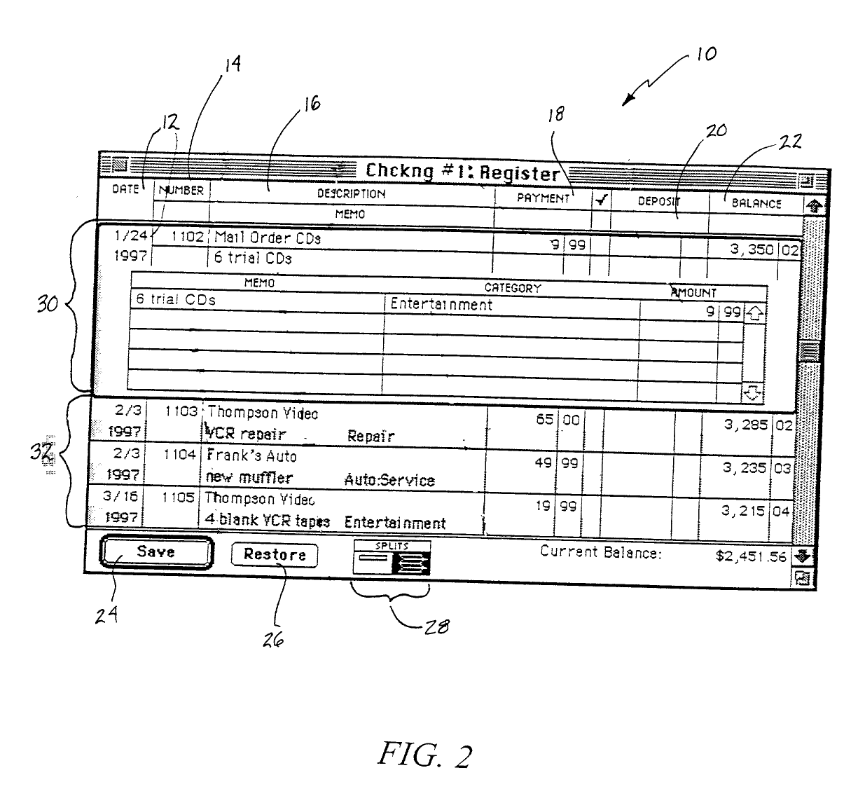

FIG. 2 is an illustration of a checking register screen 10 of an already-existing personal financial software program as displayed graphically on a computer screen of a suitable computing system. The checking register screen 10 is “user friendly” having been designed to look like a simple checkbook. By way of example only, the already-existing personal financial software may comprise Quicken® personal financial software manufactured and sold by Intuit Corporation. It is to be readily understood, however, that any number of other commercially available personal financial software programs may be employed with the warranty/guarantee tracking software upgrade according to the present invention. It will also be recognized by those skilled in the art that such already-existing personal financial software is operable within any of a variety of computing systems comprising, by way of example only, a personal computer having a microprocessor and memory for storing and executing the personal financial software, a computer display for visually communicating graphics and/or textual information to a user, and an input device such as a keyboard and/or mouse for allowing a user to input information into the personal financial software being run on the personal computer.

The checking register screen 10 includes a variety of items for documenting or “posting” check transactions, such as a date entry column 12, a check number column 14, a description column 16, a payment column 18, a deposit column 20, and balance column 22. Also provided are a save button 24 for saving the contents of the checking register, a restore button 26 for restoring the contents of the checking register, and a splits button 28 for allowing a user to selectively enter each checking transaction in either an “open-split” format or a “close-split” format. The “open-split” entry format may be selected by clicking the mouse on the darkened right side of the splits button 28, which places a given transaction in the open-split mode as represented by the transaction denoted at 30. The “close-split” entry format may similarly be selected by clicking the mouse on the lightened left side of the splits button 28, which places a given transaction in the close-split mode as represented by each of the three separate transactions shown at 32. The “open-split” entry format also includes window having a memo column 34, a category column 36, and an amount column 38.

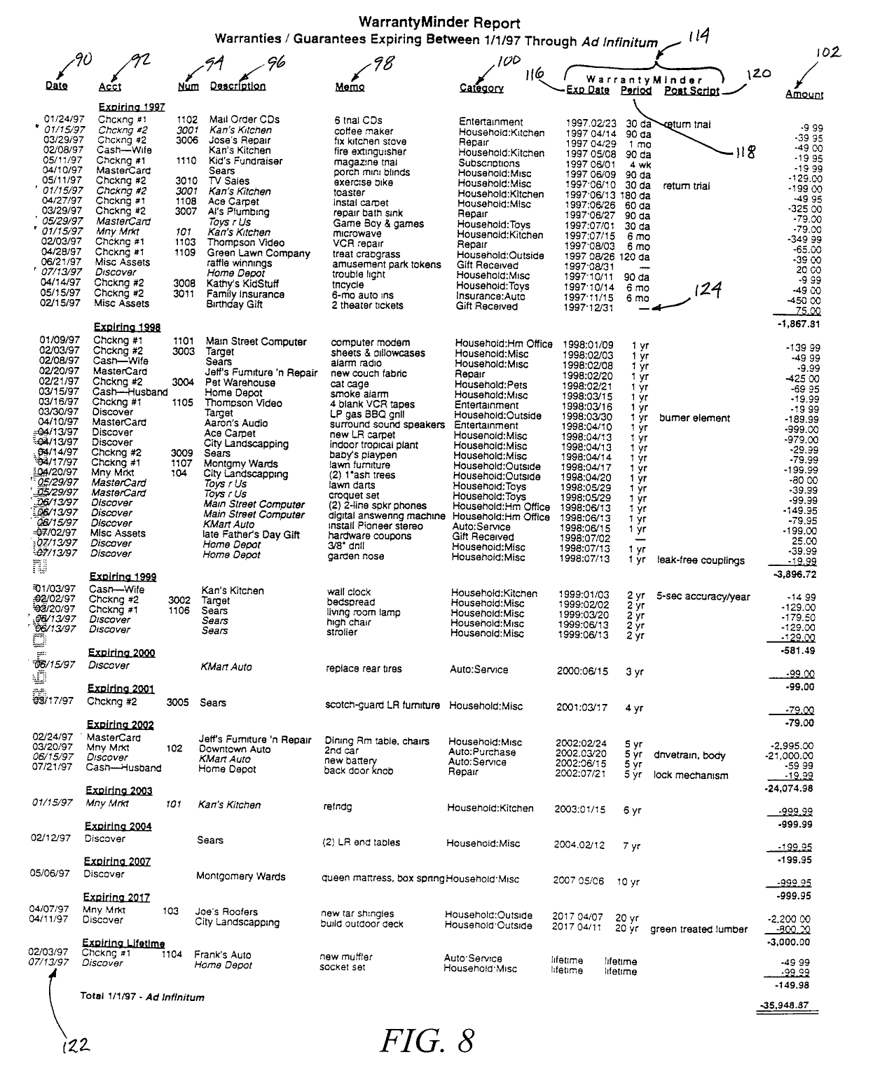

For illustration purposes, the open-split entry shown at 30 denotes a checking transaction wherein check number 1102 was made payable to Mail Order CDs on Jan. 24, 1997 in the amount of $9.99. In this example, the consumer/user created a reference memo in the memo column 34 indicating that this transaction was for 6 trial CDs and, under the category column 36, classified this expense as entertainment. The close-split entries shown at 32 include a first checking transaction wherein check number 1103 was made payable to Thompson Video on Feb. 3, 1997 in the amount of $65.00, a second checking transaction wherein check number 1104 was made payable to Frank's Auto on Feb. 3, 1997 in the amount of $49.99, and a third checking transaction wherein check number 1105 was made payable to Thompson Video on Mar. 15, 1997 in the amount of $19.99. All four transaction examples (plus several other examples), along with all the respective detail contained within each transaction example, may be organized in reports such as those illustrated in FIGS. 6 and 8.

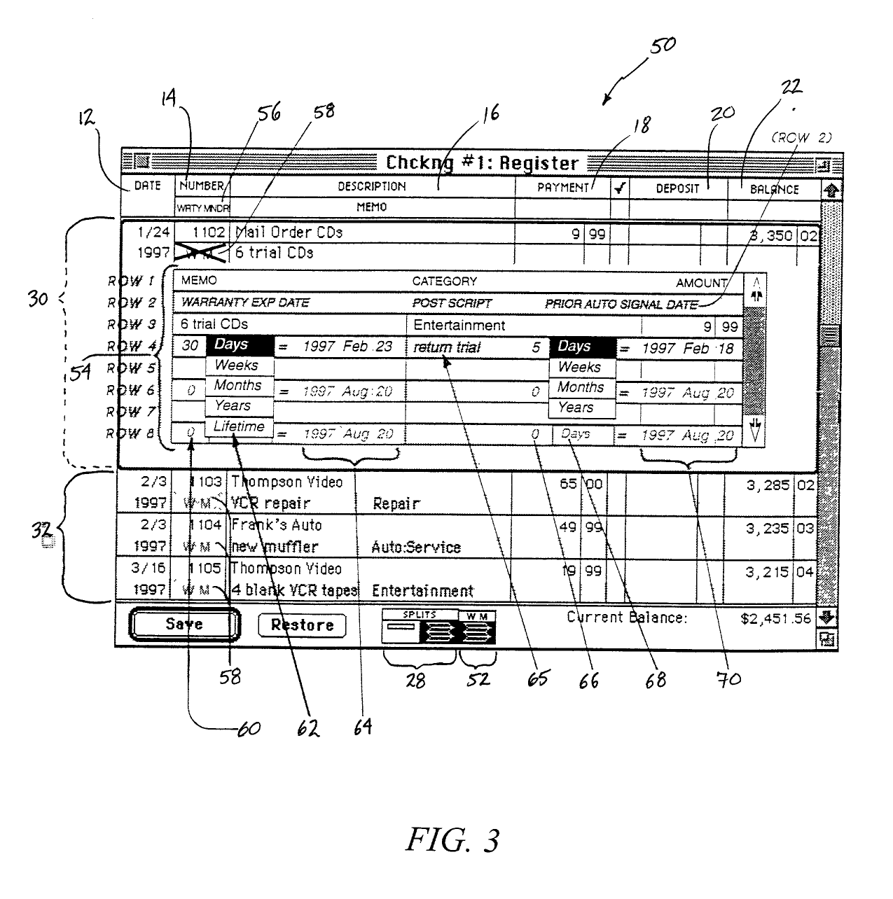

FIGS. 3 and 4 illustrate a checking register screen 50 employing the warranty tracking software improvement of the present invention. In addition to the check posting features shown and described with reference to the checking register screen 10 in FIG. 2, the checking register screen 50 includes a WM button 52 for activating the warranty tracking or “WarrantyMinder” feature of the present invention, additional rows of warranty information disposed within an open-split warranty window shown generally at 54, a “WarrantyMinder” box 56 located beneath the check number column 14 in the header area of the screen 50, and “WarrantyMinder” boxes 58 associated with each posted transaction.

In one embodiment, the WM button 52 is located proximate to the splits button 28. In operation, the WM button 52 works similarly to the darkened right side of the splits button 28 in that, by “clicking on” the WM button 52, the given transaction splits open as at 30. As will be described in greater detail below, the open-split warranty window 54 includes a plurality of gray-screen rows (rows 2,4,6,8 in the embodiment shown) for receiving warranty information. These gray-screen rows, sometimes referred to herein as “warranty rows,” are interspersed between lighter rows (rows 1,3,5,7 in the embodiment shown) which correspond to the rows within the open-split window 30 shown in FIG. 2. The splits button 28 preferably works in the same manner as described above with reference to FIG. 2 such that activating the splits button 28 alone causes the consumer/user to access the normal, routine open-split window 30 shown in FIG. 2 without activating the gray-screen warranty rows 2,4,6,8.

In this exemplary embodiment, the open-split window 54 includes rows 1-8. The odd numbered rows 1,3,5,7 contain no background coloring and are those ordinarily provided as part of the open-split window functions of the already-existing personal financial software as shown in FIG. 2. The even numbered rows 2,4,6,8 each have a gray-screen background and are designed to contain a variety of warranty information in accordance with the warranty tracking system of the present invention. Row 2 is a header or title row denoting the titles of three optional items of data (“Warranty Exp. Date,” “Post Script,” and “Prior Auto Signal Date”) that can be entered in accordance with the warranty tracking improvement of the present invention. In one embodiment, row 4 includes the warranty information for row 3, row 6 includes the warranty information for row 5, and row 8 includes the warranty information for row 7.

In one embodiment, the “WarrantyMinder” boxes 58 include the letters “W M” (as an abbreviation of “WarrantyMinder”) and a large “X.” The warranty tracking feature of the present invention becomes activated as soon as warranty information is entered into one or more of the gray-screen warranty rows 4,6,8 for a given check entry. When this happens, the “X” within the “WarrantyMinder” box 58 associated with the entry will preferably appear in bold over the letters “W M.” If there are no entries of warranty information within warranty rows 4,6,8 for given checking entry, then the warranty tracking feature of the present invention will not be activated such that the “X” within the associated “WarrantyMinder” box 58 will appear in phantom over the letters “W M.”

In one embodiment, the warranty tracking system of the present invention may be activated by: (a) using a mouse to “click” on the “X” in the “WarrantyMinder” boxes 58; or (b) using a mouse to “click” on the “WarrantyMinder” button 52 (described in more detail below) and typing in or otherwise entering specific warranty information as described herein. When the warranty tracking feature of the present invention is activated, the following three modifications take place: (1) the “W M” and the large “X” become bold; (2) the given transaction splits open as at 30 including the open-split warranty window 54; and (3) any warranty information (expiration date, post script description, and/or prior automatic signal date) entered in any of the rows 4, 6, and/or 8 may thereafter be employed to notify the consumer/user of just-about-to-expire warranties according to the notification methods set forth, by way of example only, in blocks 3-6 in FIG. 1.

Each warranty row 4,6,8 is preferably designed to contain and subsequently report the three types of warranty information corresponding to the titles or headings in row 2, namely, the warranty expiration date, a post script description of the warranty item, and a prior automatic signal date used to notify the consumer/user of an impending warranty and/or guarantee expiration date. Entering dates into the “Warranty Exp. Date” and “Prior Auto Signal Date” areas within rows 4,6,8 may preferably be facilitated by designing each row 4,6,8 to appear, when not activated, with the numerals and text disposed therein provided in gray-screen or phantom lettering and, when activated, with the numerals and text disposed therein provided in a normal dark typeface.

The “Warranty Expiration Date” area within rows 4,6,8 preferably contains a day number area designated generally at 60 to accept numbers ranging from 1 to 366. The day number may be selected by either directly typing a given number within the range of 1 to 366 or by rapid automatic advance or rapid automatic decline utilizing the “+” or “−” keys on the keyboard. A pull-down menu 62 is also provided for highlighting and selecting one of a variety of predetermined time periods, including in one embodiment days, weeks, months, years, or lifetime. The predetermined time periods within the pull-down menu 62 may also be selected by typing in the first letter of the corresponding choice (e.g., “m”=months, “1”=lifetime, etc.). The “Warranty Expiration Date” area within rows 4,6,8 also includes a future date area designated generally at 64 which will calculate and display the date on which the particular warranty will expire based on the range of days selected in day number area 60, the predetermined time period selected in the pull-down menu 62, and transaction date associated with each warranty entry.

It is anticipated that the personal financial software embodying the warranty tracking feature of the present invention may be set up such that a default number of days and a default predetermined time period will appear within the day number area 60 and pull-down menu 62, respectively, when a given transaction is split open for the purpose of posting warranty information. This may be accomplished, for example, by entering the “preferences” menu of the personal financial software and setting the default values. A consumer/user may also choose to bypass the day number area 60 and pull-down menu 62 in the event the expiration date is a pre-determined, already-fixed date in the future. In this event, the consumer/user may simply “tab over” via the tab key on the keyboard or use the mouse to “click” in the future date area 64. The future date area 64 preferably contains boxes for designating various calendar dates, including the year, the month, and the day of the month. In a preferred embodiment, the year, month, and day of the month may be selected within the future date area 64 by simply typing in this information or rapidly advancing or reversing utilizing the “+” or “−” keys on the keyboard.

The “Post Script” area within each warranty row 4,6,8 comprises a small data entry window or box with room for approximately 20 characters. In this fashion, a specific post script description as at 65 may be entered within each warranty row 4,6,8 so as to augment the information provided in under the “memo” and “description” of each checking transaction entry. This advantageously increases the amount of information available to the consumer/user to ensure that they are apprised of the warranty or guarantee associated with a given transaction.

The “Prior Automatic Signal Date” area within each warranty row 4,6,8 is used to notify the consumer/user of a just-about-to-expire warranty/guarantee and functions virtually identically to the “Warranty Expiration Date” area discussed above. This “Prior Automatic Signal Date” preferably contains a day number area designated generally at 66 to accept numbers ranging from 1 to 366. The day number may be selected by either directly typing a given number within the range of 1 to 366 or by rapid automatic advance or rapid automatic decline utilizing the “+” or “−” keys on the keyboard. A pull-down menu 68 is provided for highlighting and selecting one of a variety of predetermined time periods, including in one embodiment days, weeks, months, years, or lifetime. The predetermined time periods within the pull-down menu 68 may also be selected by typing in the first letter of the corresponding choice (e.g., “m”=months, “1”=lifetime, etc.). The “Prior Automatic Signal Date” area within rows 4,6,8 also includes a future date area designated generally at 70 which will calculate and display the date on which the particular warranty will expire based on the range of days selected in day number area 66, the predetermined time period selected in the pull-down menu 68, and transaction date associated with each warranty entry. Placing a zero “0” selection in the day number area 66 may be used to disable a given transaction's automatic signal.

It is similarly anticipated that the personal financial software embodying the warranty tracking feature of the present invention may be set up such that a default number of days and a default predetermined time period will appear within the day number area 66 and pull-down menu 68, respectively, when a given transaction is split open for the purpose of posting warranty information. This may be accomplished, for example, by entering the “preferences” menu of the personal financial software and setting the default values. The day number area 66 and pull-down menu 68 may also be bypassed in the event the expiration date is a predetermined fixed date in the future by simply “tabbing over” via the tab key on the keyboard or using the mouse to “click” in the future date area 70. The future date area 70 preferably contains boxes for designating various calendar dates, including the year, the month, and the day of the month. In a preferred embodiment, the year, month, and day of the month may be selected within the future date area 70 by simply typing in this information or rapidly advancing or reversing utilizing the “+” or “−” keys on the keyboard.

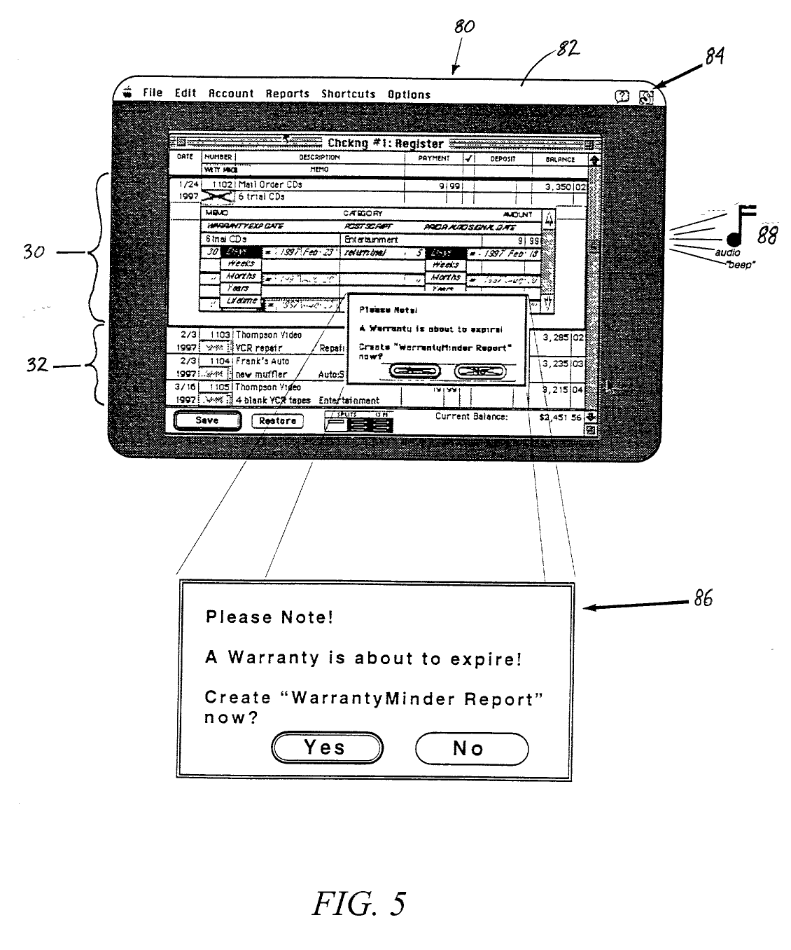

FIG. 5 is an illustration of a computer screen displaying three exemplary options for automatically signaling a forth-coming warranty/guarantee expiration date in accordance with one embodiment of the present invention. By way of example, a computer screen 80 is shown generated by the Macintosh operating system, although it is to be readily understood that any of a variety of commercially available computing environments, including Microsoft's Windows 95 operating environment, may be used to support the warranty tracking software improvement of the present invention. The computer screen 80 has a series of pull down menus displayed horizontally across a header bar 82, including “file,” “edit,” “account,” “reports,” “shortcuts,” and “options.” A financial program identification icon 84 is provided on the right side of the header bar 82 for indicating that the personal financial software is being run on the computing system.

In accordance with one embodiment of the present invention, the warranty tracking software improvement can automatically notify the consumer/user of an impending warranty and/or guarantee expiration date using one or more of the following ways. First, the warranty tracking software improvement may cause the financial program identification icon 84 to flash so as to attract the attention of the consumer/user. In one embodiment, this flashing will be made to continue until checked via the mouse, which may be accomplished by pulling down a menu associated with the program identification icon 84 to activate an expiration notification dialogue box 86. Automatic notification may also be achieved by employing an audio speaker 88 within the computing system to emit an audible notification signal, such as a “beep” alarm or a digitized human-recorded message indicating that a warranty is about to expire soon. A still further method of automatic notification is by automatically causing the expiration notification dialog box 86 to appear on the screen at a predetermined time period before the actual expiration date. In one embodiment, the expiration dialog box 86 will allow the consumer/user to generate a “WarrantyMinder Report” of the type shown in FIG. 8 in order to determine which specific warranty/guarantee is about to expire. It is to be readily understood that any combination of the foregoing automatic notification methods may be employed, such as by selecting one or more of these methods using the “preferences” menu of the personal financial software as modified by the warranty tracking software improvement of the present invention. A consumer/user may also use the “preferences” menu to select the number of times the selected automatic notifications will signal the consumer/user when the personal financial software is activated.

FIG. 6 is an illustration of a “Transactional Analysis Report” generated by a personal financial software program incorporating the warranty tracking improvement of the present invention. The “Transactional Analysis Report” lists out the personal financial information for a plurality of financial transactions, including checking transactions, cash transactions, credit card transactions, money market transactions, etc. . . . Included in this report are a “date” column 90 for recording the date of the transaction, an “account” column 92 for identifying the financial account to which the transaction should be categorized, a “number” column 94 for identifying the check or money market number for the transaction, a “description” column 96 for describing the transaction, a “memo” column 98 for listing the memo regarding the transaction, a “category” column 100 for identifying the category of the transaction, and an “amount” column 102 for documenting the amount of money involved in the given transaction, all of which are normally provided with already-existing personal financial software. In accordance with one embodiment of the present invention, the “Transactional Analysis Report” also includes an “expiration” column 104 which includes the warranty and/or guarantee expiration dates for the various personal finance transactions. This new “expiration” column 104 will also be inserted into the other appropriate already-existing reports which list and display itemized categories and itemized transactions.

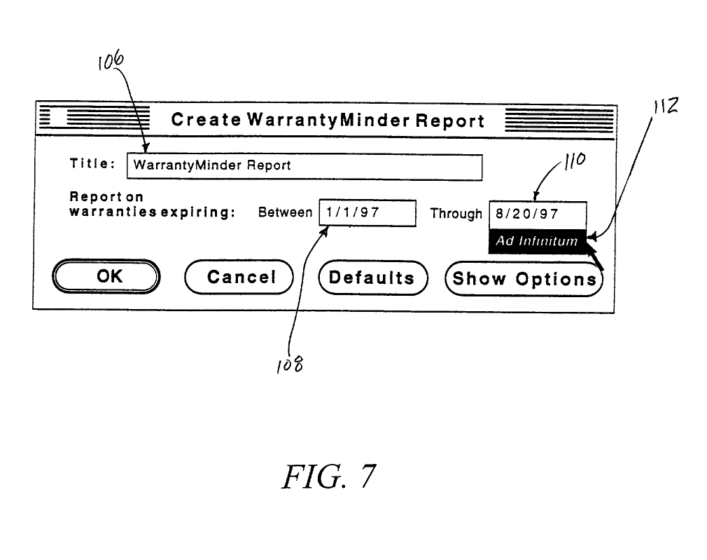

FIG. 7 is an illustration of a “Create WarrantyMinder Report” dialog box provided in accordance with the present invention for creating a newly-added “WarrantyMinder Report” such as shown in FIG. 8. The “Create WarrantyMinder Report” dialog box includes a title box 106 for designating a title, a report start date box 108 for designating a start date for reporting warranty and/or guarantee expiration dates, and a report end date box 110 for designating an end date for reporting warranty and/or guarantee expiration dates. In accordance with one embodiment of the present invention, the report end date box 110 includes a pull-down 112 wherein a consumer/user may select the end date for reporting the expiration dates of warranties as Ad Infinitum in order to include all warranty expiration dates as far into the future as the consumer/user has entered said dates (or as far as the personal financial software dates are programmed to go into the future).

FIG. 8 is an illustration of a “WarrantyMinder Report” generated by a personal financial software program incorporating the warranty tracking improvement of the present invention. The “WarrantyMinder Report” is designed to look and read very similar to any usual type of transactional analysis report, such as that shown in FIG. 6. In one embodiment, the “WarrantyMinder Report” is arranged with the transactions sorted and displayed chronologically based on the warranty expiration dates. To aid in the organization of warranty information, a “Warranty Minder” heading 114 is provided having an “expiration date” column 116, a “period” column 118, and a “post script” column 120 disposed thereunder. The “expiration date” column 116 includes the expiration dates of each of the transactional entries. The “period” column 118 denotes the duration of the warranty for each personal financial transaction. The “post script” column 120 lists the particular post script text that was entered by the consumer/user while posting the personal financial transaction. The “WarrantyMinder Report” may contain split transactions with varying warranty expiration dates. In one embodiment, the duplicate information of a split transaction is denoted by the appearance of the italicized type face such as at 122, while blanks 124 will be provided if no warranty information was specified in the day number areas 60, 66.

The warranty tracking software improvement of the present invention can employ a plurality of different techniques for entering data for the purpose of tracking warranty expiration dates. As described above, one such data entry mode is manual, whereby a consumer/user may manually enter the warranty information through the use of a computer keyboard and/or a mouse. Another technique for entering data involves downloading credit card transactions (including warranty information) over the Internet for automatic posting within the personal financial software. In this arrangement, such credit card and warranty information can be transferred via the Internet from point-of-sale (POS) terminals to the computer system of the consumer/user of the personal financial software program. Providing the warranty information and credit card information for Internet download may be accomplished by arranging to have manufacturers include warranty data on the product bar code. Under such an arrangement, a retailer would automatically scan the warranty information while scanning the price information on the product bar code, thereby requiring no additional training for POS terminal operators. Another technique for entering warranty information may involve scanning bar codes. In this embodiment, warranty information may be included on customer receipts to designate the warranty and/or guarantee associated with each particular product purchased. Scanning equipment may then be employed by the consumer/user of the personal financial software to scan the warranty and/or guarantee information for effective tracking by the software improvement of the present invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the invention is to cover all modifications, equivalents, and alternative falling within the spirit and scope of the invention as defined by the appended claims.

What is claimed is:

1. A method for tracking warranty information, comprising the steps of:
(a) providing a data entry mechanism for entering warranty information into a personal financial software program operating on a computing system;
(b) entering warranty information into said personal financial software program; and
(c) programming said personal financial software program to notify a user when a warranty within said warranty information is about to expire.

2. A method of improving a personal financial software program, comprising the steps of:
(a) programming a personal financial software program to include a data entry mechanism for entering warranty information into said personal financial software program;
(b) entering warranty information into said personal financial software program; and
(c) programming said personal financial software program to notify a user when a warranty expiration date is about to expire.

3. A method of improving the organization of personal financial information with a personal financial software program operating on a computing system, comprising the steps of:
(a) programming a personal financial software program to include a data entry mechanism for entering warranty information;
(b) entering warranty information into said personal financial software program; and
(c) programming said personal financial software program to notify a user when a warranty expiration date is about to expire.
